(19) United States
(12) Patent Application Publication
(10) Pub. No.: US 2020/0257544 A1
(43) Pub. Date: Aug. 13, 2020

(54) PERSONALIZED LANGUAGE CONVERSION DEVICE FOR AUTOMATIC TRANSLATION OF SOFTWARE INTERFACES

(71) Applicant: Goldmine World, Inc., Fairfax, VA (US)

(72) Inventor: Sung Bin Im, Fairfax, VA (US)

(73) Assignee: Goldmine World, Inc., Fairfax, VA (US)

(21) Appl. No.: 16/785,441

(22) Filed: Feb. 7, 2020

Related U.S. Application Data
(60) Provisional application No. 62/802,557, filed on Feb. 7, 2019.

(51) Int. Cl. G06F 9/451; G06F 40/47; G06F 40/58

(52) U.S. Cl. CPC G06F 9/454; G06F 40/58; G06F 40/47

(57) ABSTRACT

A system and method for providing a wireless or wired language conversion device includes a processor, a Read/Write Controller, a Communication module and a memory. The Communication module connects the device with active networked devices within its range using security code authorization. The Read/Write Controller controls writing in the memory. A language input interface is produced by a language input program executable by the processor. A plurality of words/sentences/phrases of multiple languages are stored in the memory through the language input interface from any connected device, which can display language input interface, after providing valid access information. A language selector interface is produced by a language selector program and executable by the processor. A program module is produced to be executed by external software and to read words/sentences/phrases in multiple languages from the memory while running in an external device, connected through a wired or wireless network. Software developed to include this program module can set the language per request from the wireless/wired device. The program module then sends words/sentences/phrases to the connected wireless/wired device for translation into the selected language, and a translated version is shown as the software interfaces' text on request.

This application claims priority to U.S. Provisional Patent Application No. 62/802,557 filed Feb. 7, 2019, the entire disclosure of which is incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present invention relates in general to the field of multi-lingual devices, and in particular to a language conversion device configured to provide personalized language conversion without modification to software.

### BACKGROUND

Use of software in computers and hand held devices has become a daily necessity for solving various problems and catering to various needs, and all language-speaking people need to interact with each other daily through numerous software. However, not all software provides multi-lingual capability. Some applications do not provide such capability due to the fact that the developer, publisher or owner only desires to sell such software or devices running such software among English-speaking community and others due to technical difficulties.

However there is strong demand among users to be able to use software in multiple languages. Some businessmen who sell products to multilingual customers want to display the sales data and products' information in a customer's language for better understanding of such information. Many potential customers may not understand the language of such products' data properly, and hence may not trust the brand and eventually may forego the purchase.

However, businessmen have little choice but to accept the fact because they are not technically capable of changing interfaces of software in different languages unless the software's developers do so. They may translate it themselves or with help of translators or from online resources. However they cannot display the translated text in the software interfaces.

Moreover, if requested, developers may not agree to provide a multilingual version of the software unless an exorbitant sum of money is paid by the requesting businessman.

Also, local language-speaking customers of that businessman may not understand what a generalized form of that language has translated. Some brand names in one language may not have correct translation available in other languages.

There is need for a system which owners of software can use to translate interfaces into their personalized language without having to modify the software programmatically in a manner that would require help from or cooperation by developers.

### SUMMARY

Where a software owner, or owner of a device that uses software to interface with a user, is in need of using a software interface in a personalized, multi-lingual format for their customers but does not have a viable option to have the software's developers create a new version of the software due to technical or budgetary limitations, the device described herein can create a personalized, multi-lingual version of software interfaces automatically without modification of the software itself, provided the software as developed includes a program module which is produced to communicate with the device described herein.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 is a block diagram of a wireless personalized language conversion device.

FIG. 2 is a flowchart of operations within a read/write controller.

FIG. 3 is a process diagram for a wireless personalized language conversion device's setup.

FIG. 4 is a flowchart of a program module's operations.

FIG. 5 is a block diagram of device's functionality for producing multilingual version of POS software.

FIG. 6 is a flowchart for a device driver's installation and setup.

### DETAILED DESCRIPTION

Reference will now be made in detail to the preferred embodiments of the present invention, examples of which are illustrated in the accompanying drawings. The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

In an embodiment, the present invention provides a personalized language conversion device to automatically translate software interfaces in a manner that substantially obviates one or more of the problems due to limitations and disadvantages of the related art.

An object of the present invention is to provide a device, which can generate multi-lingual version of software without having to modify the software and without any external generalized language translation, provided the software is built by including a Linker coding module to communicate with the device over wired/wireless network.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

One embodiment of the subject matter of the invention is a wireless/wired language conversion device including a processor, a Read/Write Controller, a communication module and a memory. The communication module connects the device with all active networked devices within its range by security code authorization. The Read/Write Controller controls writing in the memory. A language input interface is produced by a language input program and executable by the processor. A plurality of words/sentences/phrases of multiple languages can be stored in the memory through language input interface from any networked device, which can display language input interface, after providing valid access information in Read/Write Controller for granting Write Access. A language selector interface is produced by a language selector program and executable by the processor. A program module is produced to be executed by external software and to read plurality of words/sentences/phrases of multiple languages from the memory while running in an external device, connected through wired/wireless network. Software developed by including this program module, can set language for request from the wireless/wired device, which is connected with requesting device through network. The included program module then sends words/sentences/phrases to the connected wireless/wired device for translation in the selected language, selected by language selector program, and translated version is shown as the software interfaces' texts on request.

Another embodiment of the subject matter of the invention is a method for storing and retrieving translated text content to/from a Memory (104) based on privileged granted by a Read/Write Controller (103), which receives the authorization from a processor (105) that checks the provided security key with Device Access or Write Access Security Key, stored in Memory (104), before granting permission. This method includes receiving the translated content from communication module (106) and checking requested access with processor (105) before eventually granting permission to write the content to Memory (104) where request for such permission is made and provided Write Access Key matches the stored access key in Memory (104). This method also includes reading data from Memory (104) where No request is made to write data and finally sending the fetched data from Memory (104) to communication module (106) for broadcasting.

Another embodiment of the subject matter of this invention is a method for Device's owner to store the Device Access Security Code (304) and Write Access Security Code (305) in the Memory (104) by providing such codes in a programmed interface (301) generated by processor (105). This method includes a method for Device's owner to generate new customized language option by providing new language name (306) and new language symbol (307) in a programmed interface (302) generated by processor (105). This method also includes a method for Device's owner to input translated word/phrase/sentence (309) in newly created language against default word/phrase/sentence (308) in a programmed interface (303) generated by processor (105).

Another embodiment of the subject matter of this invention is a program module which, when included in a software, can detect text change event (402) of controls within that software. This program module includes method to detect if default language (403) is selected by the user, otherwise it can send modified text to device (404) and receive translated text from device (405) over wired/wireless network. This program module also includes method to change source control's text to translated text (406) after receiving translated text from device.

Another embodiment of the subject matter of this invention is a method for use of this device with software where two users may need to see the text content in two different languages, like, Restaurant POS software. There, sitting before a Dual Screen Monitor First User/Operator (508) may choose to select Default Language for the software from Personalized language options for selection (505), displayed in his/her window (501), generated in processor (105) while another foreign language-speaking Second User/Customer (509) may choose his/her own language from Personalized language options for selection (505), displayed in his/her window (501), generated in processor (105). If the software is developed including device's program module, is connected with the Device through wired/wireless network and the displays of Dual Screen Monitor are using separate processors to communicate with the Device, then First User's window (503) can display text content in First user's selected language (506) while Second User's window (504) can display text content in Second user's selected language (507).

Another embodiment of the subject matter of this invention is a method for installing this Device's Driver in a Device that will run software, developed using this device's program module. There, Device Driver's Installer displays input interface for device access and write access security code (604). Installation can only continue if Device Access Security code provided (606), however Write Access Security Code is not mandatory to get Device driver installation completed (608).

Also described herein are one or more exemplary implementations of method and apparatus and for use with a software's user interface that displays different languages for the customer and worker partaking in a business transaction.

The device may be portable to allow its owner to carry it around any business establishment to be utilized by multiple network connected devices in a store, building, market, restaurant or the like.

The device 100 has similar features to most communication devices. But a PC, a workstation, a dumb terminal or any other manner of system can use it without any limitation for translation of software installed therein. In the embodiment, the power supply 102 can convert any AC source to a DC source as required to run the integrated circuits embedded in the device 100.

However, it is not limited to any fixed AC source and can be used with DC source or any power bank, which can produce the required energy for running all apparatus therein the device 100. All embedded circuits required to run operations of device 100 are connected with power supply 102 in order to maintain availability of those chips while continuing process cycle.

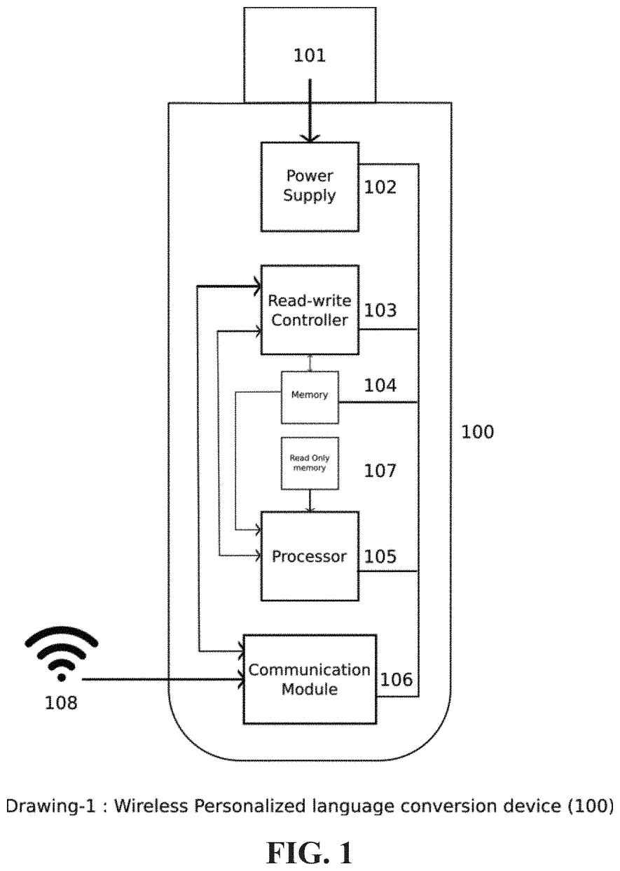

The read/write controller 103 manages read/write access to the device's memory as per setup configuration provided by owner of the device. The read/write controller 103 is an integrated circuit which can be used on stand-alone basis or just as like it is shown in FIG. 1, i.e. embedded in the device.

Memory 104 is a storage memory. This memory is used to store data such as a security code for access to the device, write access code for writing data to the device, main operating program that controls functionality of the device, etc.

The memory 104 is also writable by external data or signal. The memory is used to store the customized translation of default text content of software. Hence it is important to restrict access to write in the memory. The read/write controller 103 does that exactly.

There is another memory within the device. It is read only memory 107. It contains assembly level programs for running basic operation of the device.

Another integral circuit of device 100 is a processor 105. A processor is used to run all logical, arithmetical and analytical operations of a circuit. Embedded processor in device 100 can be configured to perform such operations.

As because the processor 105 runs fundamental operations of the device, hence it is linked with read only memory 107 as well as memory 104 and read/write controller 103.

Apart from aforesaid embedded chips, there is another integral module in this device that is communication module 106. The WIFI module 106 can be a standard communication module to communicate with other nearby devices within its range. This communication module also works following basic principal of wired/wireless communication and works in similar way as other communication devices. Communication module 106 can send and receive data from connected devices in wireless/wired mode without any connected wire. That is why this device 100 can work in a wireless/wired mode.

All apparatus embedded therein device 100 is made active by connecting it to a power source 101. Connection with Power source 101 makes the power supply 102 active. Power supply 102 sends live signal to all other connected circuits. When communication module 106 receives incoming data or signal 108, then it sends the signal for verification to read/write controller 103. Read/write controller 103 checks the data/signal for read/write access with processor 105.

On receiving request from 103, processor 105 verifies the provided security key with devices access or write security key stored in memory 104. Once processor 105 verifies the access code to match with stored security code, it sends OK signal to read/write controller 103. After receiving OK signal, 103 allow input data/signal to read/write from/to memory 104. Once data is read, in case of read operation, read/write controller sends the fetched data to communication module 106 which can transmit it back to the requesting device through wired/wireless communication 108.

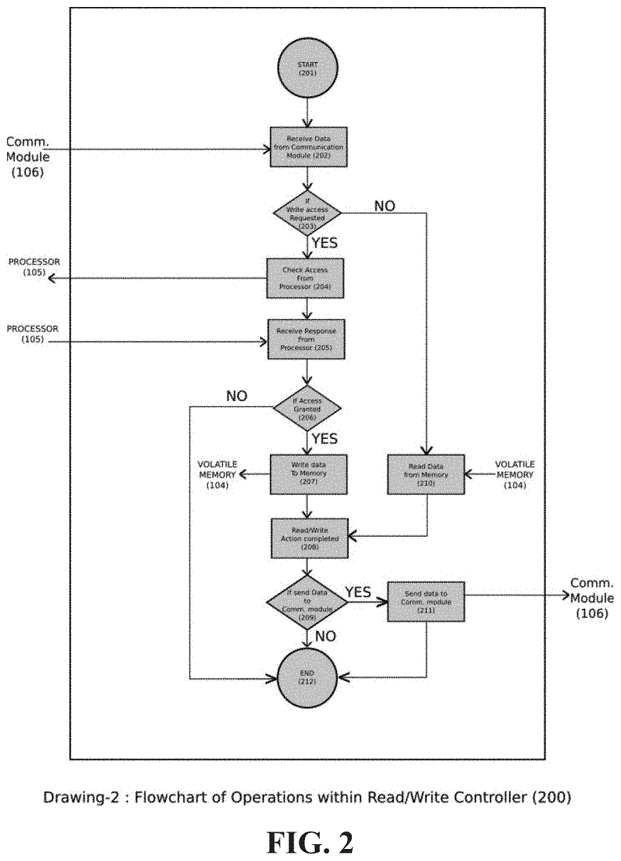

FIG. 2 is a flowchart depicting another embodiment of a method of communication with device 100 from an external network connected device. When the device 100 receives data to its communication module 106, then the signal is marked as to receive data from communication module 202. This action reflects data from communication module to the device's read/write controller. Read/write controller checks if write access requested 203. If write access is requested, then it checks the access from processor 204.

After verifying the access information, processor 105 sends the decision command to read/write controller 205. Read/write controller checks if access granted 206. If it's affirmative, then it writes data to memory 207. Otherwise the process is terminated. This way write action is completed 208.

In the case of a read operation, when write access is not requested 203, request signal read data from memory 210. Reading data from volatile memory completes the read action. After reading data is completed the read/write controller checks whether to send the data to communication module 209. If it is yes, then the data is sent to communication module 211, otherwise the process is terminated as completed 212.

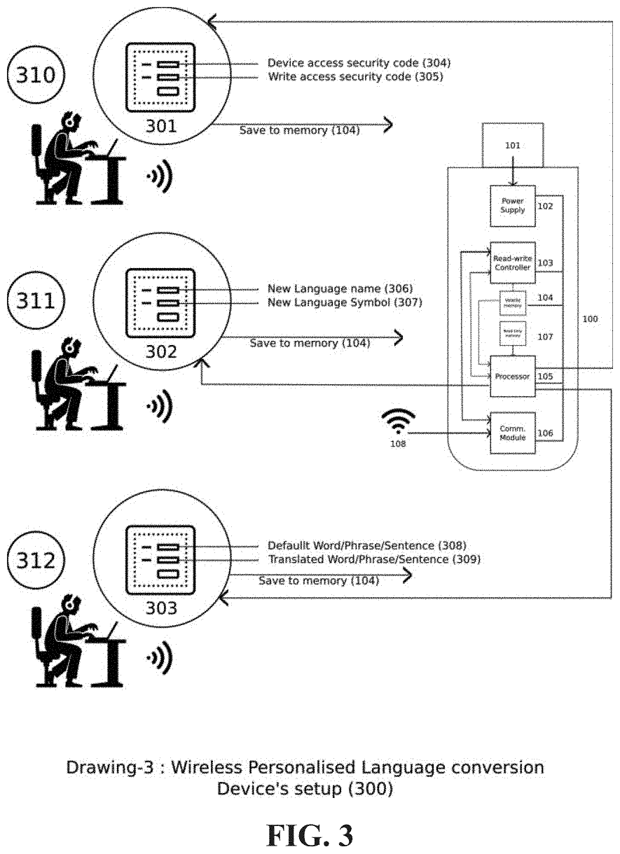

FIG. 3 is a flow diagram depicting another embodiment of a method 300 to setup wireless/wired personalized language conversion device from a computer or any other terminal which is connected with the device through network. When a person owns device 100, he/she need to setup basic aspects of device which is important from the perspective of securing the data and protecting the device against unwanted access. A user interface is stored in the memory and displayed by a user program generated from the processor. This program 301 provides option for device owner to set device access security code and write access security code. Device access security code prevents the device from anonymous use by any network connected computer, terminal etc. Write access security code protects the translation stored in the memory of device 100. Translation stored in memory is important for displaying content of linked software. Therefore, this write-access security code 305 authorizes any write request before overwriting translated content in memory. Any program module, which links to the device 100, needs to provide device access security code for linking and reading data. Also, if any program module needs to write data in memory of device 100, then the program module must provide write access security code to perform such action.

Another embodiment of this method is to create new language that will be used for displaying software content on network connected devices. This method 311 uses a language input interface stored in the memory and generated by processor. An input program accepts new language name 306 and new language symbol 307 like icon for ease of selection, through the language input interface 302.

Another embodiment of this method is to create or update word, phrase and sentences in user-defined language against default language of software. This method 312 displays a input interface 303 which comes from a language input program which is stored in memory and generated by the processor. The language input program receives translated word/phrase/sentence 309 against default word/phrase/sentence 308 of software.

For example, if software is developed keeping in mind the translation function of device 100, then when a person owns this device, he/she may input all the words/phrase/sentence of that software in the device as default language. Then owner of device 100 may create another language of his/her choice. After creating another language, he/she may provide personalized translated word/phrase/sentence to the device's memory as per his/her choice. This invention provides option for users to create his/her own language and translation because there are many cases like translation of Brand names, local product names, places' names and other special phrases where no generalized version of translation in a particular language following its dictionary may fit. In case of a business, where its operator speaks in a language and customers speaks in different language, translation of those terms in such version, deem necessary by the business owner, is important. This is because customers who come to the business for purchasing a particular product may see that product's name in his/her language but may not understand it as it is translated in a generalized version following that language's dictionary. However, owner of that business may know that exact term in translated language or may hire a skilled person for such purpose. Thereafter, those terms translated in specialized format will make the customers familiar with the intended product more easily. Henceforth, application of such translation for a multilingual version of software will enable the business to make sale to a prospective customer by reaching him/her in his/her local language.

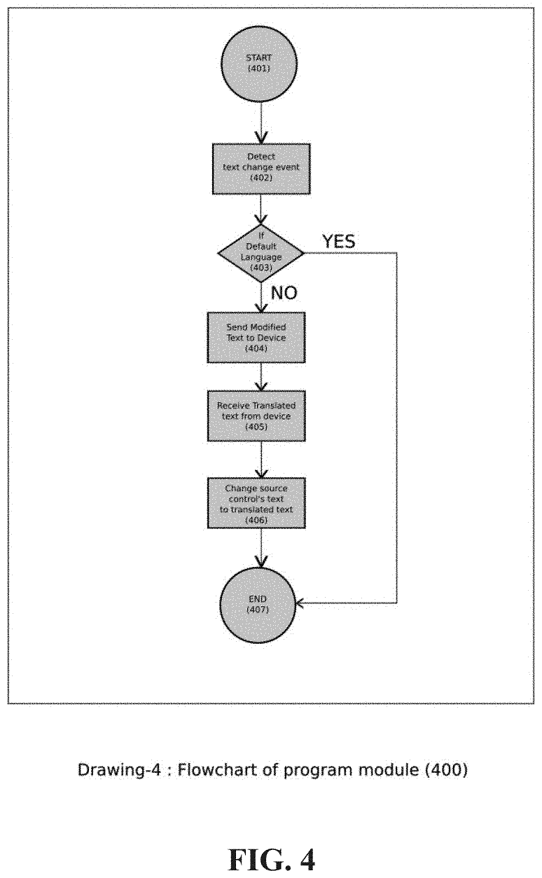

FIG. 4 is a flowchart depicting another embodiment of a method for using a program module for communication with device 100. The flowchart 400 conveys how a program built by including this program module can translate software content to a new language without any modification to the software's source code. This program module is built with the sole purpose of capturing software's text content while being generated and get it translated from device 100 before displaying on screen of the device which is executing the software. Only mandatory assumption is that the software is built by including this program module within its source code. When a text change event 402 is detected in the software, the program module checks whether if default language 403 is pre-selected for use in the software. If default language is pre-selected, then the process terminates 407. Otherwise the program module sends modified text to device 404 and receives translated text from device 405 through network. After receiving translated text, the program module change source control's text to translated text 406 for display in the monitor connected to the device running the software.

For example, if a Restaurant POS software is developed including this program module within its source code, then whenever a text change event occurs in the software, the program module will send the default language text of software for translation and if the computer running this software is connected with device 100 through network then it will receive translated text from the device and display that translation on screen. Henceforth, owner of the software can use translated version of restaurant POS by using this device without making any change in the source code of the software. This process obviates the omission of Programmer's intervention for development of multilingual version of software. Whenever owner of software, built with this program module, feels necessity of a multilingual interface, he/she may own this device, make necessary translation of software's text content and get a translated version of the software in his/her personalized translation done with his created language.

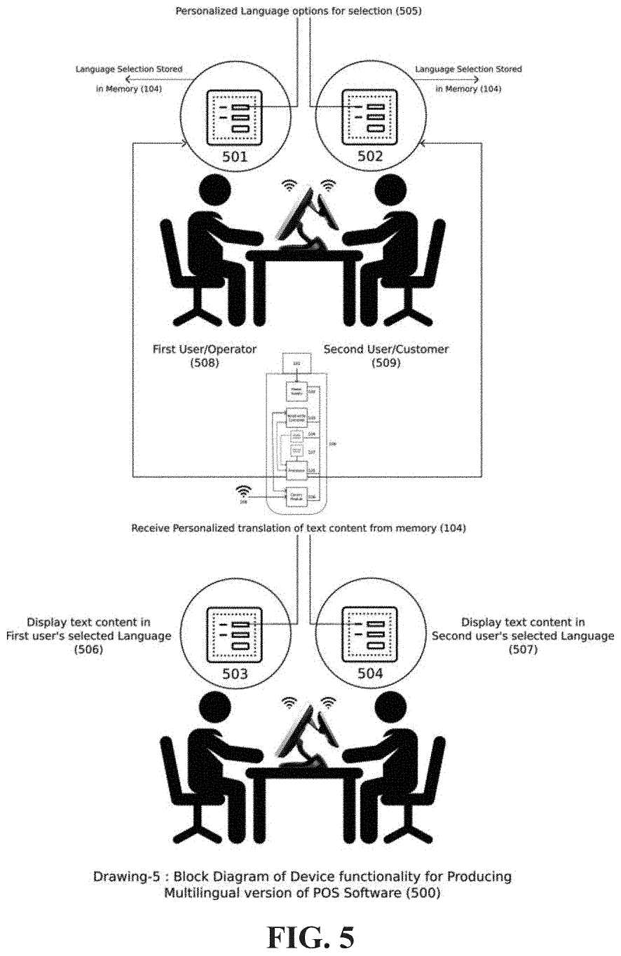

FIG. 5 is a block diagram of device functionality for producing multilingual version of POS software 500. Wherein this method depicts an embodiment for use in case of POS software, however use of this device is not restricted to POS software only and it can be used in any software which requires translation of its content without changing source code. There may be instances in a business where first user/operator 508 may understand one language while second user/customer 509 may be speaking another language. In case of system like a dual screen monitor, where each screen is connected to a different processor and communication module and both the system is connected to the device 100, operator is displayed an interface 501 for selection of his choice of language while another language speaking customer is displayed similar interface 502 for selecting own language of choice.

Business owner who has already setup this device 100 will be soul authority for creating those language options and its corresponding translation of words/phrases/sentences. Personalized language options for selection 505 will consist of those preset languages. Language choice of each user is saved to the device along with the requesting identity of computer/terminal etc. like an IP, a terminal ID, etc. Once language option is set, whenever the software loads different interfaces for each of its user, text change event occurs. On initiation of such event, the included program module within the software sends the default language text as per users choice and displays the translated version on screen from the device's memory.

For example, if a foreign language speaking customer comes to a native English speaking restaurant, then the customer can choose his language by symbol, preset by owner of the business in the device and, then on-wards customer can see all text contents of the software in his/her own language as translated by owner of the restaurant while the operator sitting next to him/her facing another display screen may keep seeing the text content in native English as per choice of the operator. Thus providing this functionality, this device enables businesses to bridge communication gap due to language through software, which was originally not built for that purpose.

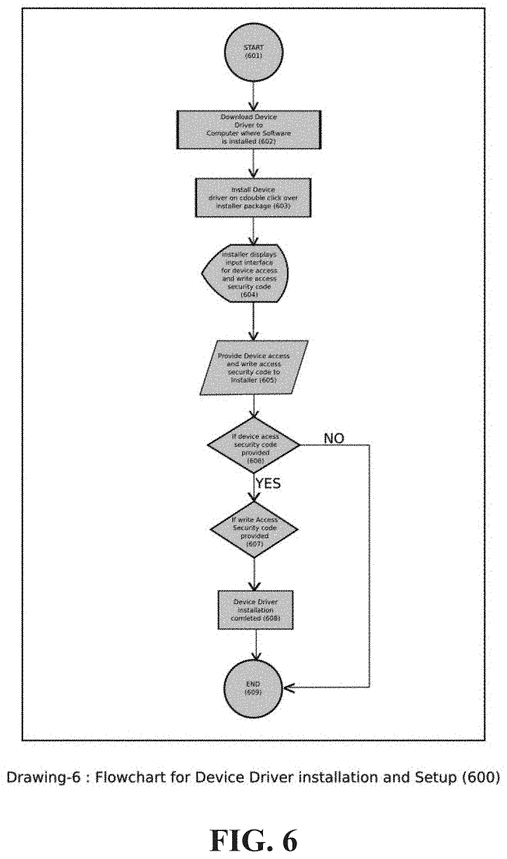

FIG. 6 is a flowchart depicting another embodiment of a method for device driver installation and setup. When a processor access this device through network, it needs to provide certain security codes for access and write data to the memory of device 100. This process necessitates means for storing those access code in a secure way such that user does not have to provide it again and again repeatedly for each attempt to access the device and similarly it should not be easy to know those security codes without certain technical knowledge and decryption of computer algorithms. A software package called device driver is provided along with the device to its owner to accomplish such mean. This method also depicts a mean to download device drivers to computers where intended software for translation is installed 602. Owner of the device should install device driver on double-click over installer package 603. Proceeding step of the installer displays input interface for device access and write access security code 604. A legitimate owner of the device will know those security codes because he is the person who has setup those codes. This method ensures that access to the device does remain classified to its owner only and by providing it in the installer of device driver 605, it is assured that the codes are saved in the memory and need not be provided for access repetitively.

Providing device access security code is mandatory 606 for the installation process to continue. Otherwise it will terminate 609. However, write access security code is optional up to the step when device driver installation is completed 608.

To summarize all embodiments of this invention, a user of this device needs to provide device access and write-access security code after owning the device. Thereafter, he/she may own software, which is developed including the program module for communication with the device. After installing the software, device owner need to install device driver in the computer/terminal etc. where he/she has installed the software. Then he/she must provide device access and write access security code that he has preset in the device. Thereafter, if he/she creates a language by accessing the device from any computer, terminal etc. and provides all default/translated text content of the software in language input interface for storing in the device, then on wards any multilingual user who accesses the software will get option for selection of language from a language selection interface. After selecting language option from language selection interface, the user of this software can view text contents of software in his/her selection of language as translated by owner of device. This way, a business owner can translate his/her business software with this device without any modification within the software's source code. This enables business owners who use software for running their businesses to translate interfaces of software without any modification to its source code and henceforth his/her customers can view all products and billing information in their native languages making them understand correctly and enabling them to impose their choice in a manner which befits their exact mindset. This method also enables the businessman to reach multilingual customers with products, which would not be sold otherwise due to linguistic barrier.

Reference in this specification to “an embodiment” or “the embodiment” means that a particular feature, structure, or characteristic described in connection with the embodiment is included in at least an embodiment of the disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention is described above with reference to block diagrams and operational illustrations of methods and devices to provide personalized language conversion. It is understood that each block of the block diagrams or operational illustrations, and combinations of blocks in the block diagrams or operational illustrations, may be implemented by means of analog or digital hardware and computer program instructions. These computer program instructions may be stored on computer-readable media and provided to a processor of an ASIC, general-purpose computer, special purpose computer, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

At least some aspects disclosed can be embodied, at least in part, in software. That is, the techniques may be carried out in a special purpose or general-purpose computer system or other data processing system in response to its processor, such as a microprocessor, executing sequences of instructions contained in a memory, such as ROM, volatile RAM, non-volatile memory, cache or a remote storage device. Functions expressed in the claims may be performed by a processor in combination with memory storing code and should not be interpreted as means-plus-function limitations.

Routines executed to implement the embodiments may be implemented as part of an operating system, firmware, ROM, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine-readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

As used herein, and especially within the claims, ordinal terms such as first and second are not intended, in and of themselves, to imply sequence, time or uniqueness, but rather are used to distinguish one claimed construct from another. In some uses where the context dictates, these terms may imply that the first and second are unique. For example, where an event occurs at a first time, and another event occurs at a second time, there is no intended implication that the first time occurs before the second time. However, where the further limitation that the second time is after the first time is presented in the claim, the context would require reading the first time and the second time to be unique times. Similarly, where the context so dictates or permits, ordinal terms are intended to be broadly construed so that the two identified claim constructs can be of the same characteristic or of different characteristic.

The above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention. The above description and drawings are merely illustrative of the present invention and that changes in components, structure and procedure are possible without departing from the scope of the present invention as defined in the following claims. For example, elements and/or steps described above and/or in the following claims in a particular order may be practiced in a different order without departing from the invention. Thus, while the invention has been particularly shown and described with reference to embodiments thereof, it will be understood by those skilled in the art that various changes in form and details may be made therein without departing from the spirit and scope of the invention.

What is claimed is:

1. A system for a wireless or wired device, comprising:
a processor;
a memory;
a Read/Write controller;
a Communication module;
a language input interface produced by a language input program stored in the memory and executable by the processor;
a security code input interface produced by a security code input program stored in the memory and executable by the processor;
a program module that can communicate with a networked device from software that has been built by including said program module;
a device driver program installable in external devices and configured to communicate with the networked device from external devices where it is installed.

2. The system for a wireless or wired device of claim 1, wherein the device is configured to convert a compatible single language software that includes said program module to a multilingual version, such that developers of said software need not provide any mean for making said software multilingual.

3. The system for a wireless or wired device of claim 1, wherein the device is configured to convert any compatible (Developed by including program module of claim 1) single language software to its (software's) multilingual version with languages and translations (not automatically generated translation, in colloquial language) provided by owner of this device.

4. The system for a wireless or wired device of claim 1, wherein the device is configured to store translations of language, as provided by a developer or owner of the device or translator or any skilled person, in a memory.

5. The system for a wireless or wired device of claim 1, wherein the device is configured to convert any compatible single language software to multilingual software with only the help of translated text content of that software, without any modification of source code.

6. The system for a wireless or wired device of claim 1, wherein the device is configured to obviate elimination of multilingual versions of software and to enable users to purchase any single language software, that includes said program module, then load the device with a translation of said software's content repeatedly so as to provide a multilingual version of said software with that translated content.

7. The system for a wireless or wired device of claim 1, wherein the device will enable its users to use translation of Nouns, Brand names and others in particular word/phrases/sentences which user may think to be correct in colloquial language.

8. The system for a wireless or wired device of claim 1, wherein the language input interface is displayable in a display of connected external device that is connected through network.

9. The system for a wireless or wired device of claim 1, further comprising the security code input interface being displayable in a display of connected external device that is connected through network.

10. The system for a wireless or wired device of claim 1, further bundled with a program module that can communicate with networked device from software that has been built by including this program module.

11. The system for a wireless or wired device of claim 10, wherein said program module is configured to sense text change events of controls of software built by including said program module.

12. The system for a wireless or wired device of claim 10, wherein said program module is configured to send modified text content to the wireless or wired device and receive translated text content in return.

13. The system for a wireless or wired device of claim 1, bundled with said device driver program, wherein said device driver program is configured to be installable in external devices and to communicate with said networked device from external devices where said device driver is installed.

14. The system for a wireless or wired device of claim 13, wherein said device driver program is configured to store security codes for accessing and writing to the wireless or wired device, in memory of devices where said device driver program is installed.

15. The system for a wireless or wired device of claim 1, configured to be portable.

16. The system for a wireless or wired device of claim 1, configured to communicate through a wired network, Bluetooth, or Wi-Fi.

17. The system for a wireless or wired device of claim 1, wherein the device usage is configured so as not to be restricted by mode of communication such as wired network, Bluetooth and Wi-Fi.

18. The system for a wireless or wired device of claim 1, configured to be stationary/fixed.

19. The system for a wireless or wired device of claim 1, wherein the data stored in the memory includes a plurality of languages and identifiers.

20. The system for a wireless or wired device of claim 19, configured such that the plurality of languages and identifiers can be created by an owner/operator of the device.

21. The system for a wired or wireless device of claim 1, further comprising a language selection interface configured to be displayable in a display of an external device that is connected through a network.

22. The system for a wired or wireless device of claim 1, wherein said program module is configured to sense text change events of controls of software configured to include said program module within source code.

23. The system for a wired or wireless device of claim 22, configured such that on occurrence of a text change event in controls of software configured to include said program module within source code, said program module sends text content of a source control over said network to said wired or wireless device, which is connected with said device executing said software.

24. The system for a wired or wireless device of claim 22, configured such that said program module receives translated content from said wired or wireless device, which is connected with the device executing software configured to include said program module within source code, over network, so as to display said translated content as text content of a requesting control of said software.

25. A method for creating a new language for a wired or wireless electronic device and storing translated words/phrases/sentences in accordance with a selection by an owner/operator of the wired or wireless electronic device, comprising the steps of:
providing at least one name and symbol for a new language over a language input interface that is displayable on a display of a device connected with the wired or wireless device through a network and a program that generates the interface and runs from a processor of the wired or wireless device; and,
storing default text content of software and translated text content of software in said new language in memory of the wired or wireless device through the language input interface, the language input interface being displayable on said display of the device that is connected with said wired or wireless device through said network and said program that generates the interface.

26. A method for securing Read/Write access to a memory of a wired or wireless device, comprising the steps of:
storing device access and write access security codes to the memory of said wired or wireless device through a security code input interface that is displayable on a display of a device that is connected with said wired or wireless through a network and a program that generates said interface and runs on the processor of said wired or wireless device.
storing device access and write access security codes to the memory of said wired or wireless device, where a device driver program is installed, through an interface displayable on a display of a device that is connected with the said wired or wireless device through a network, and where said interface is to be part of installation steps that complete installation of a device driver program; and,
authorizing each of a plurality of requests to read/write from/to the memory of the said wired or wireless device with the stored security codes through the Read/Write Controller of said wired or wireless device.

27. A method for displaying software interfaces in multiple languages, comprising the steps of:
displaying a language selector interface comprising a plurality of language options created by an owner or operator of a wired or wireless device, on a display to an operator or customer viewing said display, the device having a device driver program installed and said wired or wireless device being connected through a network;
receiving selection of a language from said operator/customer and storing said selection to the memory of device of said wired or wireless device;
accepting default text content of software configured to include a program module in source code, to the memory of said wired or wireless device over said network when a text change event to said software's controls occurs;
searching for translated content within a memory of said wired or wireless device, in a language option which is pre-selected by an operator or customer viewing the display of a device having a device driver program installed;
sending translated content from said wired or wireless device to said device having the device driver program installed and to which the wired or wireless device is connected through network, unless a translation is not found for said requested content in said selected language option;
receiving translated content from said wired or wireless device and displaying said translated content as a requesting control's content for software configured to include a program module in source code, on a display to an operator or customer viewing said display of said device having said device driver program installed.
